(19) United States
(12) Patent Application Publication
(10) Pub. No.: US 2003/0174156 A1
(43) Pub. Date: Sep. 18, 2003

(54) Display monitor apparatus

(76) Inventors: Noriaki Katsuhara, Kyoto (JP); Yoshihiro Tada, Kyoto (JP); Hiromi Uenoyama, Kyoto (JP)

Correspondence Address: RADER, FISHMAN & GRAUER PLLC, David T. Nikaido, Suite 501, 1233 20th Street, N.W., Washintgon, DC, 20036, US

(21) Appl. No.: 10/365,407

(22) Filed: Feb. 13, 2003

(30) Foreign Application Priority Data
Feb. 15, 2002 (JP) 2002-038010

(51) Int. Cl. G09G 5/00

(52) U.S. Cl. 345/700

(57) ABSTRACT

A display monitor apparatus has an analog signal input portion for receiving an analog video signal. a digital signal input portion for receiving a digital video signal, a detector portion for detecting a particular component included in the analog video signal, a first property data storage portion for storing a first set of property data used to control the display monitor apparatus to cope with the analog video signal, a second property data storage portion for storing a second set of property data used to control the display monitor apparatus to cope with the digital video signal, and a switch portion for choosing one of the first and second property data storage portions. When the detector portion detects the particular component included in the analog video signal, the display monitor apparatus reads the first set of property data from the first property data storage portion to achieve display based on the analog video signal and, otherwise, the display monitor apparatus reads the second set of property data from the second property data storage portion to achieve display based on the digital video signal.

### BACKGROUND OF THE INVENTION

1. Field of the Invention

The present invention relates to a display monitor apparatus provided with a detection device that automatically distinguishes between an analog and a digital video signal output from an apparatus, such as a personal computer, provided with a video card so as to permit the display monitor apparatus to be controlled properly with the analog or digital video signal according to the result of the detection.

2. Description of the Prior Art

FIG. 4 is a block diagram showing how a personal computer and a display monitor apparatus are connected together on an analog basis conventionally. Conventionally, image display on a personal computer 1 is achieved by transmitting, in the form of an analog signal, the video signal produced by a video card 2 incorporated in the personal computer 1 to a display monitor apparatus 4, such as an LCD or CRT, designed to operate with an analog video signal by way of a cable 3 or the like conforming to the VGA standard. Thus, the transmission of the video signal is achieved on an analog basis. From the analog video signal thus fed thereto, the display monitor apparatus 4 produces images according to the property data of the display monitor apparatus 4 read from a ROM 5 it incorporates.

However, an analog signal is susceptible to the noise generated by the video card of the personal computer which produces the video signal itself and to the distortion that the signal suffers while it is being transmitted. This results in ghosts and color bleeding on the monitor screen.

On the other hand, as personal computers advance in performance and functionality, display monitor apparatuses have come to be required to meet increasingly strict requirements and provided with increasingly large screens. Thus, the VGA standard, which is based on analog technology, is approaching its limits. To overcome this, attempts have been made to produce a digital video signal on a personal computer, transmit it on a digital basis, and produce images on a display monitor apparatus designed to operate with a digital video signal.

FIG. 5 is a block diagram showing how a personal computer and a display monitor apparatus are connected together on a digital basis conventionally. In FIG. 5, image display on the personal computer 11 is achieved by making the video card 12 incorporated therein produce a digital video signal and transmitting it, in the form of a digital signal, to a display monitor apparatus 14, such as an LCD or CRT, designed to operate with a digital video signal by way of a digital cable 13 or the like. Thus, the transmission of the video signal is achieved on a digital basis. From the digital video signal thus fed thereto, the display monitor apparatus 14 produces images according to the property data of the display monitor apparatus 14 read from a ROM 15 it incorporates.

One of such attempts for digitalization is the DVI (digital visual interface) standard formulated by DDWG (Digital Display Working Group) as an international standard for digital interfacing between a video card of a personal computer and a display monitor device. Nowadays, it is quite common to incorporate a video card conforming to DVI in a personal computer to produce a digital video signal, transmit it as it is, i.e., in the form of a digital signal, by way of a DVI-D cable or the like, and produce images on a digital display monitor apparatus conforming to DVI.

However, to cope also with existing personal computers that produce an analog video signal, a display monitor apparatus conforming to DVI is usually provided with separate connectors so as to accept either of an analog and a digital cable. To avoid this inconvenience, DDWG formulates specifications for a DVI-I cable, which has an analog and a digital transmission line incorporated into a single cable.

As described above, a display monitor apparatus conforming to DVI is usually provided with separate connectors, one for analog connection and another for digital connection, and is designed to cope with either of an analog and a digital signal. However, with a display monitor apparatus so designed, whether an analog or digital signal is fed thereto needs to be stored therein beforehand by manually setting, by the use of OSD (on-screen display) or dip switches, the property data stored in the display monitor apparatus together with other settings related thereto.

### SUMMARY OF THE INVENTION

An object of the present invention is to provide a display monitor apparatus that does not require manual entry of the type of video signal, analog or digital, whichever is fed thereto, specifically a display monitor apparatus provided with a detection device that permits the display monitor apparatus to automatically recognize the type of video signal fed thereto and that permits the result of the detection to be fed to the controller of the display monitor apparatus.

To achieve the above object, according to the present invention, a display monitor apparatus is provided with: an analog signal input portion for receiving an analog video signal; a digital signal input portion for receiving a digital video signal; a detector portion for detecting a particular component included in the analog video signal; a first property data storage portion for storing a first set of property data used to control the display monitor apparatus to cope with the analog video signal; a second property data storage portion for storing a second set of property data used to control the display monitor apparatus to cope with the digital video signal; and a switch portion for choosing one of the first and second property data storage portions. Here, when the detector portion detects the particular component included in the analog video signal, the display monitor apparatus reads the first set of property data from the first property data storage portion to achieve display based on the analog video signal and, when the detector portion does not detect the particular component included in the analog video signal, the display monitor apparatus reads the second set of property data from the second property data storage portion to achieve display based on the digital video signal.

In the display monitor apparatus described above, the particular component may be a vertical synchronizing signal included in the analog video signal.

Alternatively, in the display monitor apparatus described above, the particular component may be a horizontal synchronizing signal included in the analog video signal.

Moreover, in the display monitor apparatus described above, the detector portion may produce a signal with which to operate the switch portion by rectifying and smoothing the vertical or horizontal synchronizing signal.

Alternatively, the detector portion may produce a signal with which to operate the switch portion by detecting the particular component and making a latch circuit latch the result of detection for the period for which the particular component persists.

Moreover, according to the present invention, the first and second property data storage portions may be realized as storage areas secured as two banks within a nonvolatile rewritable memory, with the bank switch portion of the nonvolatile rewritable memory serving as the switch portion.

Furthermore, in this case, the result of detection by the detector portion may be stored in the nonvolatile rewritable memory so that the display monitor apparatus thereafter achieves display by reading one of the first and second sets of property data according to the result of detection stored in the nonvolatile rewritable memory.

Moreover, the display monitor apparatus may conform to the DVI standard.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram showing how a personal computer and a DVI-conforming display monitor apparatus are connected together on an analog basis according to the invention;

FIG. 2 is a block diagram showing how a personal computer and a DVI-conforming display monitor apparatus are connected together on a digital basis according to the invention;

FIG. 3 is a circuit diagram showing an outline of a DVI-conforming display monitor apparatus according to the invention and its analog/digital detector;

FIG. 4 is a block diagram showing how a personal computer and a display monitor apparatus are connected together on an analog basis conventionally; and

FIG. 5 is a block diagram showing how a personal computer and a display monitor apparatus are connected together on a digital basis conventionally.

### DESCRIPTION OF THE PREFERRED EMBODIMENTS

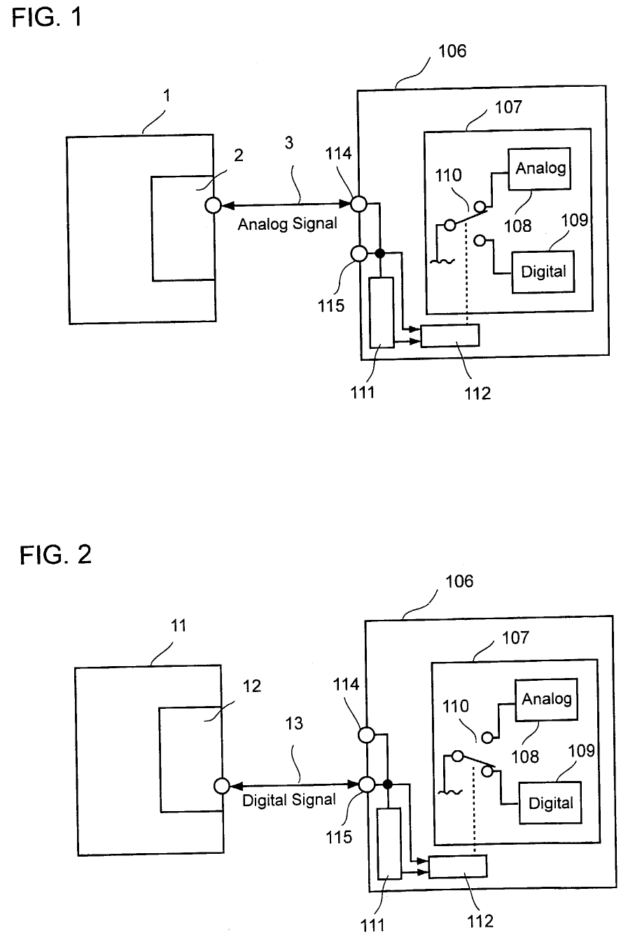

FIGS. 1 and 2 show examples of embodiments of the invention. In FIG. 2, such elements as find their counterparts in FIG. 1 are identified with the same reference numerals. The configuration shown in FIG. 2 is basically the same as that shown in FIG. 1. Hereinafter, embodiments of the invention will be described with reference to the accompanying drawings. FIG. 1 is a block diagram showing, as one embodiment of the invention, how a personal computer and a display monitor apparatus conforming to DVI are connected together on an analog basis. The personal computer 1 is provided with a video card 2 that produces an analog video signal.

The display monitor apparatus 106 conforms to the DVI standard, and is provided with an analog input connector 114, a digital input connector 115, an analog/digital detector 111, a ROM 107 having an analog property data portion 108 for storing parameters for analog display and a digital property data portion 109 for storing parameters for digital display, a controller portion 112, and a switch portion 110 controlled by the controller portion 112.

The analog video signal produced by the video card 2 is fed, by way of an analog cable 3 and the analog input connector 114, to the controller portion 112 of the DVI-conforming display monitor apparatus 106. Part of the input signal that is used to distinguish between an analog and a digital signal is fed to the analog/digital detector 111, which outputs a detection signal, which also is then fed to the controller portion 112.

In this example, the analog/digital detector 111 detects an analog signal, and therefore the controller portion 112 controls the switch portion 110 in such a way that the DVI-conforming display monitor apparatus reads the necessary parameters from the analog property data portion 108 of the ROM 107 and decodes the analog video signal according to those parameters to reproduce images.

Next, the operation for digital transmission will be described. FIG. 2 is a block diagram showing, as another embodiment of the invention, how a personal computer and a display monitor apparatus conforming to DVI are connected together on a digital basis. The personal computer 11 is provided with a video card 12 that produces a digital video signal.

The display monitor apparatus 106 conforms to the DVI standard, and is configured just as described above with reference to FIG. 1.

The operation is as follows. The digital video signal produced by the video card 12 is fed, by way of a digital cable 13 and the digital input connector 115, to the controller portion 112 of the DVI-conforming display monitor apparatus 106. Part of the input signal that is used to distinguish between an analog and a digital signal is fed to the analog/digital detector 111, which outputs a detection signal, which also is then fed to the controller portion 112.

In this example, the analog/digital detector 111 detects a digital signal, and therefore the controller portion 112 controls the switch portion 110 in such a way that the DVI-conforming display monitor apparatus reads the necessary parameters from the digital property data portion 109 of the ROM 107 and decodes the digital video signal according to those parameters to reproduce images. Instead of controlling the switch portion 110, it is also possible to specify an address in the ROM 107 according to a signal output from the controller portion 112. In that case, parameters are read from the specified address in the ROM 107, and therefore the switch portion 110 can be omitted.

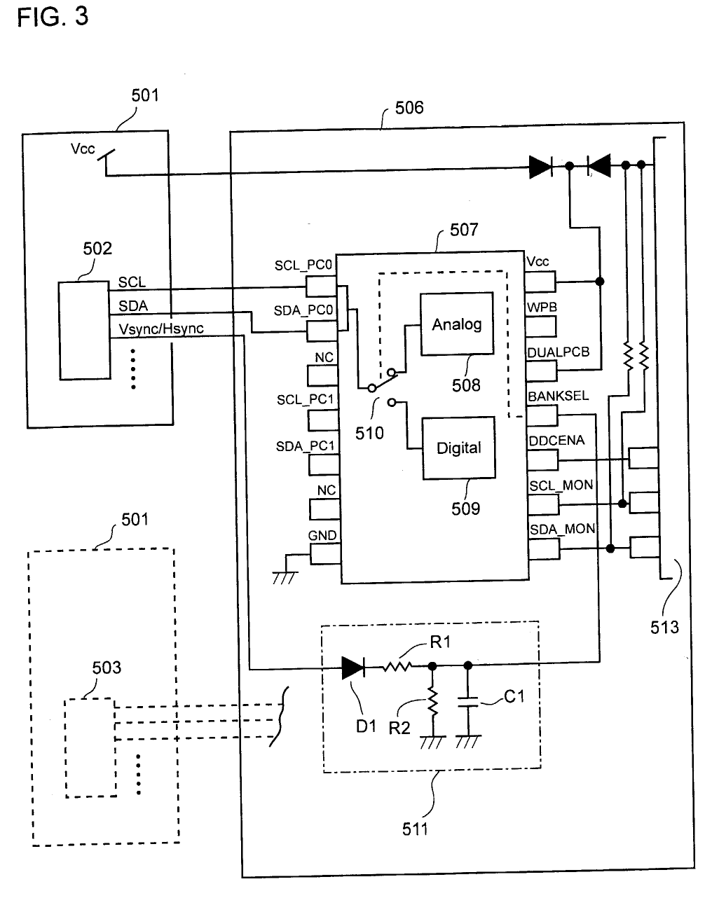

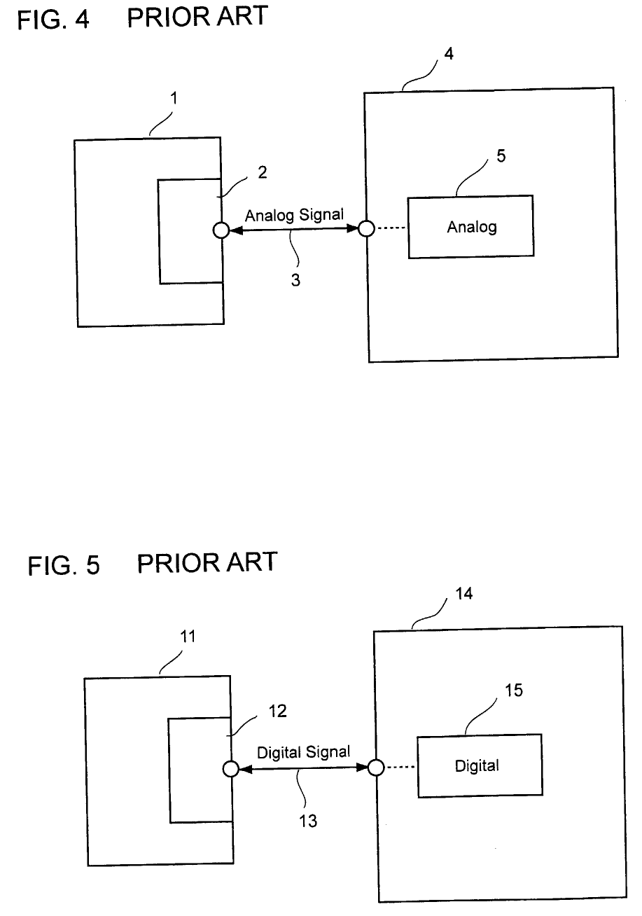

Next, an embodiment of the invention will be described in more detail with reference to FIG. 3. FIG. 3 is a circuit diagram showing an outline of a DVI-conforming display monitor apparatus and its analog/digital detector portion. A personal computer 501 is provided with a video card 502 that produces an analog video signal. As indicated with broken lines in the figure, the personal computer 501 may be provided with a video card 503 that produces a digital video signal instead.

The DVI-conforming display monitor apparatus 506 is composed of circuits and devices including a display device (not shown) such as an LCD or CRT, a CPU 513 included in the controller portion of the display monitor apparatus, a ROM 507 having an analog property data portion 508 for storing parameters needed to reproduce analog images, a digital property data portion 509 for storing parameters needed to reproduce digital images, and a switch portion 510 for switching between the analog and digital property data portions 508 and 509 according to an analog/digital detection signal, and an analog/digital detector portion 511 composed of a diode D1, resistors R1 and R2, and a capacitor C1.

Though not illustrated, the connection between the personal computer 501 having the analog or digital video card 502 or 503 and the DVI-conforming display monitor apparatus 506 may be achieved by way of either an analog or a digital cable as described earlier. FIG. 3 shows a case in which their connection is achieved by way of an analog cable. FIG. 3 shows the connection of signal lines SCL (serial clock), SDA (serial data), and Vsync or Hsync, omitting the connection for other signals.

Next, the operation of this embodiment will be described. The signal output from the video card 502 is fed to the DVI-conforming display monitor apparatus 506, with the individual components of the signal connected to the corresponding signal terminals. When the video card 502 is of an analog type, the signal output therefrom includes a vertical or horizontal synchronizing signal Vsync or Hsync. With a video card of a digital type, the signal output therefrom does not include Vsync or Hsync, because no such signals are used in digital transmission. In FIG. 3, the Vsync or Hsync signal is branched off so as to be fed to the analog/digital detector portion 511.

Next, in the analog/digital detector portion 511, the Vsync or Hsync signal is rectified by the diode D1, and is then smoothed by the resistors R1 and R2 and the capacitor C1 according to the CR constant determined by them, so that the rectified and smoothed Vsync or Hsync signal is fed, as a high-level signal, to the BANKSEL terminal of the ROM 507. When a high level is fed to the BANKSEL terminal, the switch portion 510 of the ROM 507 so switches as to choose the analog property data portion 508, and then maintains that state until a low level is fed to the BANKSEL terminal. Thus, the DVI-conforming display monitor apparatus 506 acquires, form the analog property data portion 508, the parameters needed to reproduce images from an analog video signal.

In this case, the CR constant is so determined that a high level is kept fed to the BANKSEL terminal as long as the Vsync signal is present, keeping in mind the fact that the Vsync signal usually has a frequency of 50 to 90 Hz. Accordingly, a variable resistor may be used as the resistor R1 or R2. Likewise, in a case where the Hsync signal is used instead of the Vsync signal, the CR constant is determined according to its frequency.

When a digital video card 503 is used instead of the analog video card 502, the operation is as follows. In digital transmission, no Vsync or Hsync signal is used, and therefore no Vsync or Hsync signal is fed to the analog/digital detector portion 511. Thus, a low level is fed, through the resistor R2, to the BANKSEL terminal. Accordingly, the switch portion 510 so switches to choose the digital property data portion 509, and maintains that state until a high level is fed to the BANKSEL terminal. Thus, the DVI-conforming display monitor apparatus 506 acquires, form the digital property data portion 509, the parameters needed to reproduce images from a digital video signal.

In the embodiment described above, the analog/digital detector portion 511 is configured as a rectifying/smoothing circuit. However, the analog/digital detector portion 511 may be configured in any other manner than specifically described above; for example, it may be configured as a circuit that latches the Vsync or Hsync signal for its period to keep outputting a high level for that period. The analog/digital detector portion 511 may be incorporated in the ROM 507 or the control circuit of the display monitor apparatus, or may be built in another circuit.

In the embodiment described above, in a case where the ROM 507 is realized by the use of a nonvolatile rewritable memory such as an EEPROM (electrically-erasable programmable read-only memory), the result of detection by the analog/digital detector portion 511 may be stored in a particular area in the ROM 507 for ready use so that thereafter the switching between analog and digital display is achieved on the basis of the data read from that particular area. Considering that the personal computer or the like that is connected to a display monitor apparatus is not replaced with another so often, this configuration permits the analog/digital detector portion 511 to be separated from the other circuits, and thus helps reduce electric power consumption. It is also possible to provide an additional means for switching between the configuration in which the detection result is stored for ready use thereafter and the configuration in which the distinction between an analog and digital signal is performed automatically on a regular basis.

As described above, in a display monitor apparatus according to the present invention, whether the input is an analog or digital signal is automatically distinguished, and the appropriate parameters are read out to make initial settings on the display monitor apparatus. As a result, when the display monitor apparatus is connected to a personal computer for the first time or reconnected to another, it is no longer necessary to make settings manually on the display monitor apparatus, as by the use of dip switches or OSD (on-screen display), as conventionally required. This helps save trouble, and also helps avoid malfunctioning due to wrong manual settings. Moreover, in a display monitor apparatus according to the present invention, since the necessary settings are made thereon automatically when it is connected or reconnected, it is possible to effectively exploit the plug-and-play function, which permits hot connection and disconnection of the display monitor apparatus, provided by the DVI standard. Furthermore, by incorporating the detection device in the ROM or in the control circuit, it is possible to produce the display monitor apparatus at lower costs.

What is claimed is:

1. A display monitor apparatus comprising:
an analog signal input portion for receiving an analog video signal;
a digital signal input portion for receiving a digital video signal;
a detector portion for detecting a particular component included in the analog video signal;
a first property data storage portion for storing a first set of property data used to control the display monitor apparatus to cope with the analog video signal;
a second property data storage portion for storing a second set of property data used to control the display monitor apparatus to cope with the digital video signal; and
a switch portion for choosing one of the first and second property data storage portions,
wherein, when the detector portion detects the particular component included in the analog video signal, the display monitor apparatus reads the first set of property data from the first property data storage portion to achieve display based on the analog video signal and, when the detector portion does not detect the particular component included in the analog video signal, the display monitor apparatus reads the second set of property data from the second property data storage portion to achieve display based on the digital video signal.

2. A display monitor apparatus as claimed in claim 1,
wherein the particular component is a vertical synchronizing signal included in the analog video signal.

3. A display monitor apparatus as claimed in claim 1,
wherein the particular component is a horizontal synchronizing signal included in the analog video signal.

4. A display monitor apparatus as claimed in claim 1,
wherein the detector portion produces a signal with which to operate the switch portion by rectifying and smoothing the particular component.

5. A display monitor apparatus as claimed in claim 1,
wherein the detector portion produces a signal with which to operate the switch portion by detecting the particular component and making a latch circuit latch a result of detection for a period for which the particular component persists.

6. A display monitor apparatus as claimed in claim 1,
wherein the display monitor apparatus conforms to the DVI standard.

7. A display monitor apparatus as claimed in claim 1,
wherein the first and second property data storage portions are realized as storage areas secured as two banks within a nonvolatile rewritable memory, and the switch portion is a bank switch portion of the nonvolatile rewritable memory.

8. A display monitor apparatus as claimed in claim 7,
wherein a result of detection by the detector portion is stored in the nonvolatile rewritable memory so that the display monitor apparatus thereafter achieves display by reading one of the first and second sets of property data according to the result of detection stored in the nonvolatile rewritable memory.

9. A display monitor apparatus as claimed in claim 7,
wherein the display monitor apparatus conforms to the DVI standard.
